(19) United States
(12) Patent Application Publication
(10) Pub. No.: US 2015/0355483 A1
(43) Pub. Date: Dec. 10, 2015

(54) DISPLAY DEVICE

(71) Applicant: Samsung Display Co., Ltd., Youngin-City (KR)

(72) Inventors: Tae Woo LIM, Hwaseong-si (KR); Yu Deok SEO, Hwaseong-si (KR)

(21) Appl. No.: 14/515,084

(22) Filed: Oct. 15, 2014

(30) Foreign Application Priority Data
Jun. 9, 2014 (KR) 10-2014-0069497

(51) Int. Cl. G02F 1/1334; G02F 1/1368; G02F 1/1333; G02F 1/1339

(52) U.S. Cl. CPC G02F 1/1334; G02F 1/1339; G02F 1/1368; G02F 1/133305

(57) ABSTRACT

The present system and method relate to a display device that has a constant curvature in a curved surface. A display device according to an exemplary embodiment of the present system and method includes: a bendable substrate; a thin film transistor formed on the substrate; a pixel electrode connected to the thin film transistor electrode; a roof layer disposed on the substrate and separated from the pixel electrode by a first microcavity formed in between; a liquid crystal layer disposed in the first microcavity; and an encapsulation layer formed on the roof layer and sealing the first microcavity, wherein the roof layer includes a partition formed between of the first microcavity and a second microcavity adjacent to the first microcavity, and a shape of the partition differs according to a position along a length of the substrate where the partition is disposed.

### CROSS-REFERENCE TO RELATED APPLICATION

This application claims priority to and the benefit of Korean Patent Application No. 10-2014-0069497 filed in the Korean Intellectual Property Office on Jun. 9, 2014, the entire contents of which are incorporated herein by reference.

### BACKGROUND

(a) Technical Field

The present system and method relate to a display device. More particularly, the present system and method relate to a display device that includes a constant curvature in a curved surface display device.

(b) Description of the Related Art

A liquid crystal display generally includes two display panels on which field generating electrodes such as pixel electrodes and common electrodes are formed and a liquid crystal layer that is disposed therebetween. When voltages are applied to the field generating electrodes, electric fields are generated in the liquid crystal layer, which influence the alignment, position, and/or orientation of the liquid crystal molecules in the liquid crystal layer. By controlling the strength of the electric fields being generated, a display device is able to control the polarization of incident light to display an image.

The two display panels that form the liquid crystal display may be a thin film transistor array panel and an opposing display panel. In the thin film transistor array panel, a gate line transmitting a gate signal and a data line transmitting a data signal may be formed to extend in different directions that intersect. A thin film transistor connected to the gate line and data line and a pixel electrode connected to the thin film transistor may be formed. The opposing display panel may include a light blocking member, a color filter, a common electrode, etc. In some cases, the light blocking member, the color filter, and the common electrode may be formed in the thin film transistor array panel.

In a conventional liquid crystal display, two substrates are generally used such that constituent elements are respectively formed on the two substrates. Such a conventional display device is usually heavy and associated with a high cost and long processing time.

### SUMMARY

The present disclosure provides a display device, and a manufacturing method thereof, that uses one substrate, thereby reducing the weight, thickness, cost, and processing time of the display device.

The present disclosure also provides a curved surface display device that includes a constant curvature.

A display device according to an exemplary embodiment of the present system and method includes: a bendable substrate; a thin film transistor formed on the substrate; a pixel electrode connected to the thin film transistor; a roof layer disposed on the substrate and separated from the pixel electrode by a first microcavity formed in between; a liquid crystal layer disposed in the first microcavity; and an encapsulation layer formed on the roof layer and sealing the first microcavity, wherein the roof layer includes a partition formed between of the first microcavity and a second microcavity adjacent to the firs microcavity, and a shape of the partition differs according to a position along a length of the substrate where the partition is disposed.

A planar shape of the partition positioned at a center of the substrate may be different from the planar shape of the partition positioned at an edge of the substrate.

The planar shape of the partition positioned at the center of the substrate may be a zigzag shape.

The planar shape of the partition positioned at the edge of the substrate may be a bar shape.

The partition may be formed to extend along a first direction, and the roof layer may be formed to extend along a second direction perpendicular to the first direction.

The first direction may be a vertical direction and the second direction may be a horizontal direction.

The partition may be formed between the first and second microcavities adjacent in the horizontal direction, and the roof layer may be removed between the first microcavity and a third microcavity adjacent to the first microcavity in the vertical direction.

A path may be formed in the partition positioned at the center of the substrate.

The planar shape of the partition positioned at the center of the substrate may be at least one of a quadrangle, a circle, and a triangle.

The planar shape of the partition positioned at the edge of the substrate may be a bar shape.

The partition may be formed along a first direction, and the roof layer may be formed along a second direction perpendicular to the first direction.

The first direction may be the vertical direction, and the second direction may be the horizontal direction.

The formation direction of the partition positioned at the center of the substrate may be different from the formation direction of the partition positioned at the edge of the substrate.

The formation direction of the partition positioned at the center of the substrate may be the first direction.

The formation direction of the partition positioned at the edge of the substrate may be the second direction perpendicular to the first direction.

The roof layer positioned at the center of the substrate may be formed along the second direction.

The roof layer positioned at the edge of the substrate may be formed along the first direction.

The first direction may be the vertical direction, and the second direction may be the horizontal direction.

The partition positioned at the center of the substrate may be formed between the first and second microcavities adjacent in the horizontal direction, and the roof layer positioned at the center of the substrate may be removed between the first microcavity and a third microcavity adjacent to the first microcavity in the vertical direction.

The partition positioned at the edge of the substrate may be formed between the first and third microcavities adjacent in the vertical direction, and the roof layer positioned at the edge of the substrate may be removed between the first and second microcavities adjacent in the horizontal direction.

According to the exemplary embodiment of the present invention, it is possible to reduce weight, thickness, cost, and processing time by manufacturing a display device by using one substrate.

Also, by differentiating the partition shape of the roof layer depending on the positions, the curved surface display device may have a constant curvature.

### BRIEF DESCRIPTION OF THE DRAWINGS

FIG. 1 is a perspective view of a display device according to an exemplary embodiment of the present system and method.

FIG. 2 and FIG. 3 are top plan views of an upper surface of a curved surface display device.

FIG. 4 is a top plan view of a portion of a display device according to an exemplary embodiment of the present system and method.

FIG. 5 is a circuit diagram of one pixel of a display device according to an exemplary embodiment of the present system and method.

FIG. 6 is a top plan view of one pixel of a display device according to an exemplary embodiment of the present system and method.

FIG. 7 is a cross-sectional view of the display device of FIG. 6 along a line VII-VII, according to an exemplary embodiment of the present system and method taken.

FIG. 8 is a cross-sectional view of the display device of FIG. 6 taken along a line VII-VIII, according to an exemplary embodiment of the present system and method.

FIG. 9 is a top plan view of a portion of a display device according to an exemplary embodiment of the present system and method.

FIG. 10 is a top plan view of one pixel of a display device according to an exemplary embodiment of the present system and method.

FIG. 11 is a top plan view of a portion of a display device according to an exemplary embodiment of the present system and method.

FIG. 12 is a top plan view of one pixel of a display device according to an exemplary embodiment of the present system and method.

FIG. 13 is a cross-sectional view of the display device FIG. 12 taken along a line XIII-XIII, according to an exemplary embodiment of the present system and method.

FIG. 14 is a cross-sectional view of the display device FIG. 12 taken along a line XIV-XIV, according to an exemplary embodiment of the present system and method.

FIG. 15 is a top plan view of another portion of a display device according to an exemplary embodiment of the present system and method.

FIG. 16 is a top plan view of a portion of a display device according to an exemplary embodiment of the present system and method.

FIG. 17 is a top plan view of another portion of a display device according to an exemplary embodiment of the present system and method.

### DETAILED DESCRIPTION OF THE EMBODIMENTS

The present system and method are described more fully hereinafter with reference to the accompanying drawings, in which exemplary embodiments of the system and method are shown. As those skilled in the art would realize, the described embodiments may be modified in various different ways without departing from the spirit or scope of the present system and method.

In the drawings, the thickness of layers, films, panels, regions, etc., are exaggerated for clarity and not drawn to scale. Like reference numerals designate like elements throughout the specification. It is understood that when an element such as a layer, film, region, or substrate is referred to as being “on” another element, it can be directly on the other element or intervening elements may also be present. In contrast, when an element is referred to as being “directly on” another element, there are no intervening elements present.

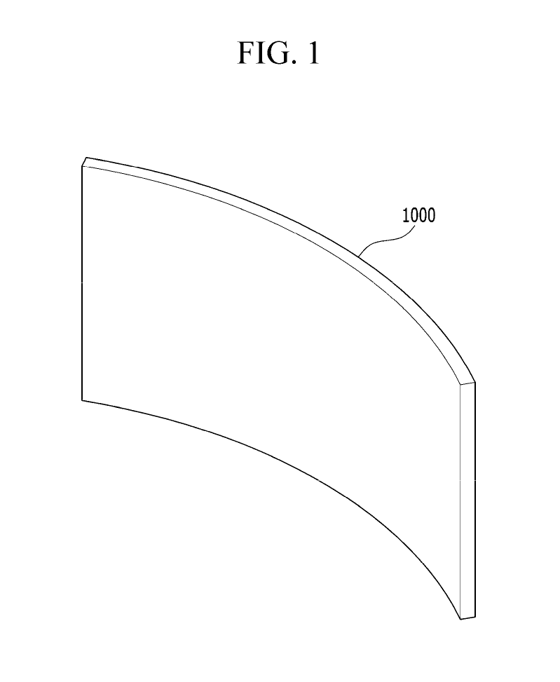

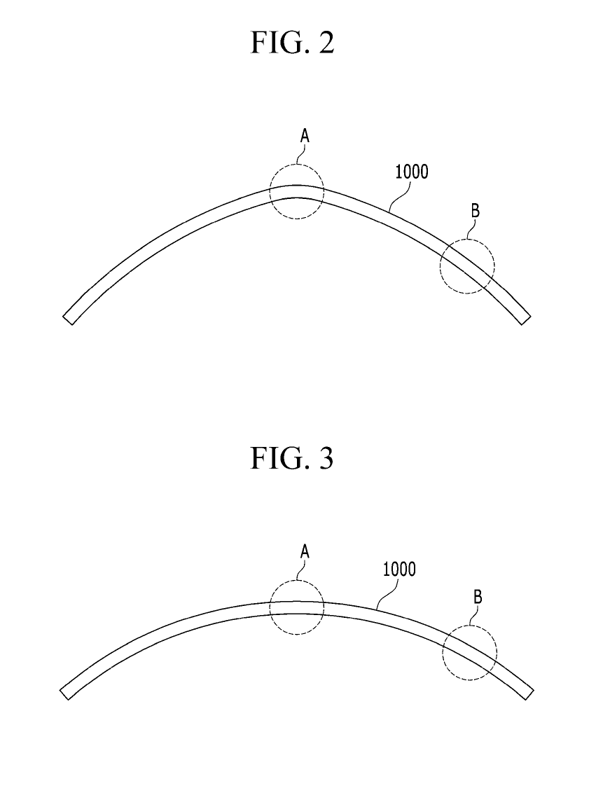

A display device according to an exemplary embodiment of the present system and method is described with reference to FIG. 1 to FIG. 3. FIG. 1 is a perspective view of a display device according to an exemplary embodiment of the present system and method. FIG. 2 and FIG. 3 are top views of an upper surface of a curved surface display device.

As shown in FIG. 1, a display device 1000 has a curved shape with a constant curvature. In the case of a flat (as opposed to curved) display device, a viewing distance may differ significantly according to a position of a screen. For example, when viewing the display device from a front of the screen, the viewing distance to an edge may be significantly longer than the viewing distance to the center of the display device. In contrast, in the case of the curved surface display device, when viewing the display device from the front of the screen, the viewing distances to different areas of the screen do not deviate as significantly, which allows for a wider viewing angle. Particularly, the distances between the eyes of the viewer and all the pixels of the display may be substantially constant if the viewer is positioned at the center of a circle having the constant curvature. Since this curved surface display device offers a wider viewing angle compared with the flat display device, it provides a larger amount of information for stimulating the viewer's photoreceptors such that more visual information may be transmitted to the viewer's brain through the optic nerves. Accordingly, a realistic, immersive view may be further enhanced.

A curved surface display device may be formed through a process of bending a flat display device after forming the flat display device. When performing the bending process on a flat display device in which all the pixels have the same structure, such as shown in FIG. 2, the degree of curvature may vary at different positions along the length of the display device 1000. That is, the display device 1000 does not have a constant curvature. For example, a region A shown in FIG. 2 has a large degree of curvature while a region B has a smaller degree of curvature.

In the display device 1000 according to an exemplary embodiment of the present system and method, by differentiating the structure of the pixels according to their positions, such as shown in FIG. 3, the display device 1000 may have a constant curvature. For example, the region A may be formed to have pixel structures that exhibit a higher resistance to bending and the region B may be formed to have pixel structures that exhibit a lower resistance to bending. Accordingly, by varying the structure of the pixels based on their bending resistance and along the length of the display device, a constant curvature, such as shown in FIG. 3, may be formed.

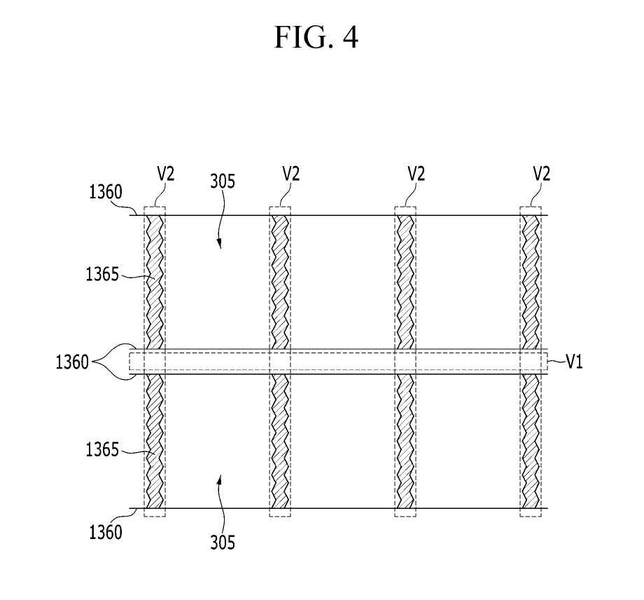

The pixels positioned at the center of a display device according to an exemplary embodiment of the present system and method are described with reference to FIG. 4 to FIG. 8. As used herein, a “center of a display device” refers to a central region of the display device. The central region, for example, may be located near the midpoint of a length of the display device.

The pixels positioned at the center of the display device according to an exemplary embodiment of the present system and method are described with reference to FIG. 4. FIG. 4 is a top plan view of a portion of a display device according to an exemplary embodiment of the present system and method. FIG. 4 shows a plurality of pixels positioned at the center of the display device. A microcavity 305 covered by a roof layer 1360 is formed on a substrate (not shown). The roof layer 1360 extends in a horizontal direction, and a plurality of microcavities 305 are formed under one roof layer 1360.

The microcavities 305 may be disposed in a matrix form in which first valleys V1 are positioned between the microcavities 305 adjacent to each other in a vertical direction, and second valleys V2 are positioned between the microcavities 305 adjacent to each other in a horizontal direction.

A plurality of roof layers 1360 are separated from each other with the first valleys V1 therebetween. That is, a roof layer 1360 does not overlap a first valley V1 in a plan view. According to an embodiment, a roof layer may have portions removed between the microcavities 305 that are adjacent to each other in the vertical direction to form the plurality of roof layers 1360. Although the microcavities 305 are covered by the roof layer 1360, they may be exposed to the outside at portions contacting the first valley V1 through structures referred to as injection holes 307a and 307b.

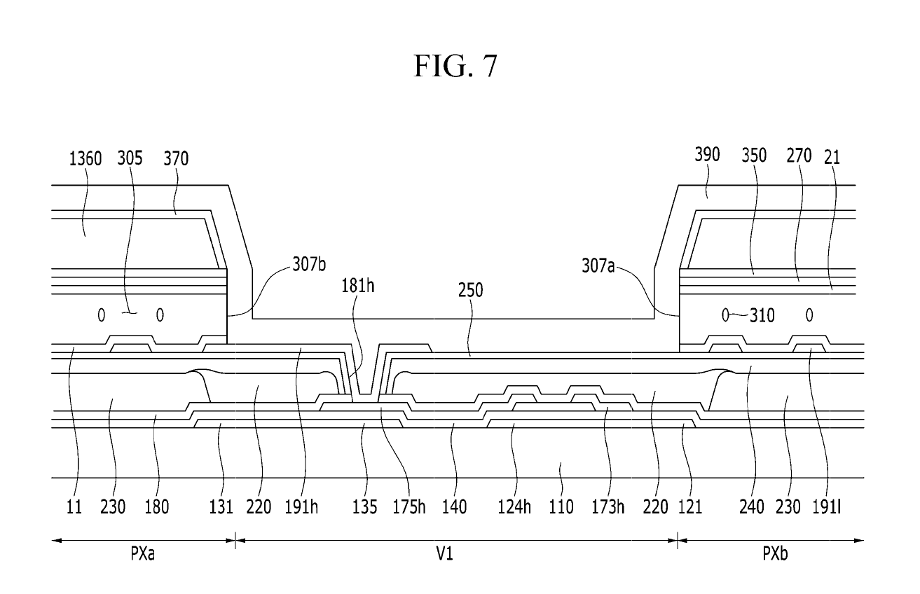

The injection holes 307a and 307b are formed at both edges of the microcavity 305, such as shown in FIG. 7. The first injection hole 307a is formed to expose a lateral surface of a first edge of the microcavity 305. The second injection hole 307b is formed to expose a lateral surface of a second edge of the microcavity 305. The lateral surface of the first edge and the lateral surface of the second edge of the microcavity 305 face each other.

Between adjacent second valleys V2, each roof layer 1360 is formed to be spaced apart from the substrate 110 with at least a microcavity 305 in between. That is, the roof layer 1360 is formed to cover residual lateral surfaces other than the lateral surfaces of the first edge and the second edge in which the injection holes 307a and 307b are formed. Accordingly, the roof layer 1360 includes a partition 1365 formed between a plurality of microcavities 305.

As the embodiment of FIG. 4 illustrates, the partition 1365 is formed in the vertical direction. That is, the formation direction of the partition 1365 and the formation direction of the roof layer 1360 are approximately perpendicular. The partition 1365 is formed between the microcavities 305 adjacent to each other in the horizontal direction. According to an exemplary embodiment of the present system and method, the partition 1365 positioned at the center of the display device has a planar shape that is a zigzag shape.

The structure of the display device described herein is just an example, and may be variously modified. For example, the layout form of the microcavities 305, the first valleys V1, and the second valleys V2 may be modified, the plurality of roof layers 1360 may be connected to each other at the first valleys V1, and a part of each roof layer 1360 may be separated from the substrate 110 at the second valley V2 such that adjacent microcavities 305 may be connected to each other. Also, although the roof layer 1360 is described above as being formed to extend in the horizontal direction and the partition 1365 being formed to extend in the vertical direction, in other embodiments, the roof layer 1360 may be formed to extend in the vertical direction and the partition 1365 may be formed to extend in the horizontal direction.

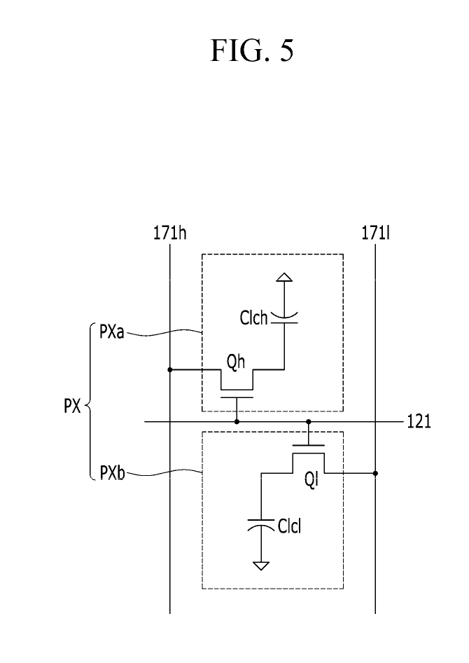

FIG. 5 is a circuit diagram of one pixel of a display device according to an exemplary embodiment of the present system and method. The display device includes a plurality of signal lines 121, 171h, and 171l, and a pixel PX connected thereto. Although not illustrated in the drawings, a plurality of pixels PX may be disposed in a matrix form that includes a plurality of pixel rows and a plurality of pixel columns.

Each pixel PX may include a first subpixel PXa and a second subpixel PXb. The first subpixel PXa and the second subpixel PXb may be vertically disposed. In this case, a first valley V1 may be positioned in a pixel row direction between the first subpixel PXa and the second subpixel PXb, and a second valley V2 may be positioned between adjacent pixel columns.

The signal lines 121, 171h, and 171l include a gate line 121 transferring a gate signal, and a first data line 171h and a second data line 171l transferring different data voltages. A first switching element Qh connected to the gate line 121 and the first data line 171h is formed. A second switching element Ql connected to the gate line 121 and the second data line 171l is formed. A first liquid crystal capacitor Clch connected to the first switching element Qh is formed in the first subpixel PXa. A second liquid crystal capacitor Clcl connected to the second switching element Ql is formed in the second subpixel PXb.

A first terminal of the first switching element Qh is connected to the gate line 121, a second terminal thereof is connected to the first data line 171h, and a third terminal thereof is connected to the first liquid crystal capacitor Clch. A first terminal of the second switching element Ql is connected to the gate line 121, a second terminal thereof is connected to the second data line 171l, and a third terminal thereof is connected to the second liquid crystal capacitor Clcl.

According to an exemplary embodiment of the present system and method, if a gate-on voltage is applied to the gate line 121, the first switching element Qh and the second switching element Ql connected thereto are turned on, and the first and second liquid crystal capacitors Clch and Clcl are charged by the different data voltages transferred through the first and second data lines 171h and 171l. The data voltage transferred by the second data line 171l is lower than the data voltage transferred by the first data line 171h. Accordingly, the second liquid crystal capacitor Clcl is charged by the voltage that is lower than that of the first liquid crystal capacitor Clch, which improves lateral visibility.

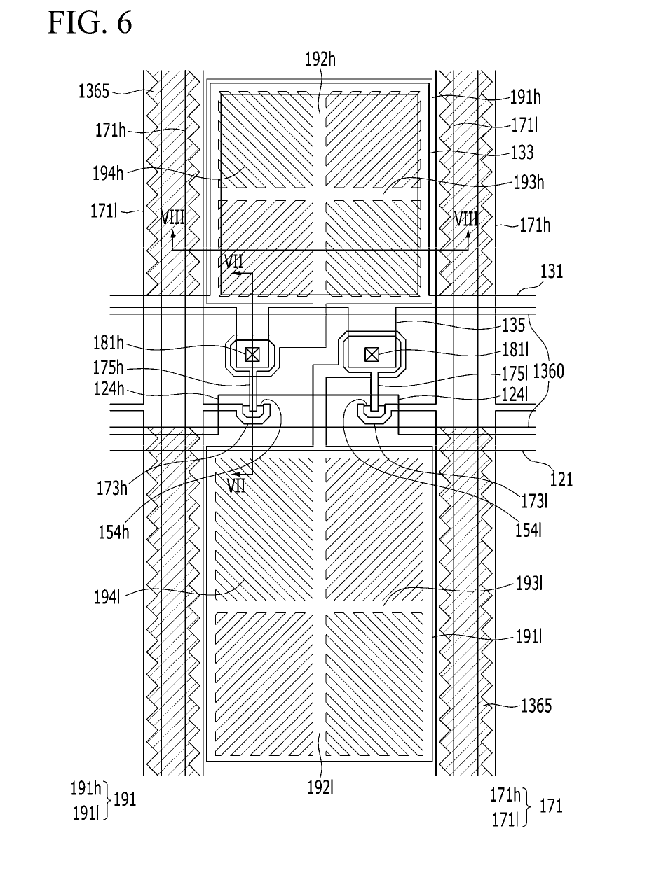

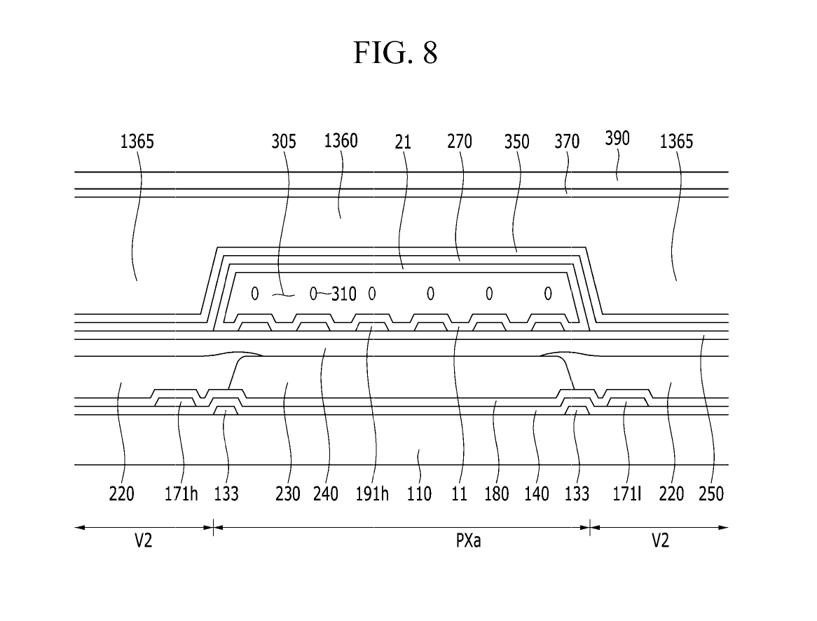

The structure of one pixel positioned at the center of a display device according to the exemplary embodiment of the present system and method is described with additional reference to FIG. 6 to FIG. 8. FIG. 6 is a top plan view of one pixel of a display device according to an exemplary embodiment of the present system and method. FIG. 7 is a cross-sectional view of the display device of FIG. 6 taken along a line VII-VII, according to an exemplary embodiment of the present system and method FIG. 8 is a cross-sectional view of the display device of FIG. 6 taken along a line VII-VIII, according to an exemplary embodiment of the present system and method. FIG. 6 to FIG. 8 show the pixels positioned at the center of the display device.

Referring to FIG. 6 to FIG. 8, the gate line 121 and first and second gate electrodes-124h and 124l-protruding from the gate line 121, are formed on the substrate 110. The substrate 110 may be formed of a bendable material, such as glass, plastic, or the like. As used herein, a “bendable” material includes any material that is capable of being formed in a non-flat shape, such as by applying a bending force or high temperature, and sustaining the non-flat shape.

The gate line 121 extends in the horizontal direction and transmits the gate signal. The gate line 121 is positioned between two microcavities 305 that are adjacent in the vertical direction. That is, the gate line 121 is positioned in the first valley V1. The first gate electrode 124h and the second gate electrode 124l protrude to an upper side of the gate line 121 as seen from the top plan view of FIG. 6. The first gate electrode 124h and the second gate electrode 124l may be connected to each other to form one protrusion portion. However, the present system and method are not limited thereto, and protrusion shapes of the first gate electrode 124h and the second gate electrode 124l can be variously modified.

A storage electrode line 131 and storage electrodes 133 and 135 protruding from the storage electrode line 131, may be further formed on the substrate 110. The storage electrode line 131 extends in a direction that is parallel with the gate line 121 and is spaced apart from the gate line 121. A predetermined voltage may be applied to the storage electrode line 131. The storage electrode 133 protrudes from the storage electrode line 131 towards the first subpixel PXa and surrounds the edge of the first subpixel PXa. The storage electrode 135 protrudes from the storage electrode line 131 away from the first subpixel and is formed to be adjacent to the first gate electrode 124h and the second gate electrode 124l.

A gate insulating layer 140 is formed on the gate line 121, the first gate electrode 124h, the second gate electrode 124l, the storage electrode line 131, and the storage electrodes 133 and 135. The gate insulating layer 140 may be formed of an inorganic insulating material such as a silicon nitride (SiNx) and a silicon oxide (SiOx). Further, the gate insulating layer 140 may be formed of a single layer or multilayers.

A first semiconductor 154h and a second semiconductor 154l are formed on the gate insulating layer 140. The first semiconductor 154h may be positioned on the first gate electrode 124h, and the second semiconductor 154l may be positioned on the second gate electrode 124l. The first semiconductor 154h may be formed beneath the first data line 171h, and the second semiconductor 154l may be formed beneath the second data line 171l. The first semiconductor 154h and the second semiconductor 154l may be formed of amorphous silicon, polycrystalline silicon, a metal oxide, or the like.

Ohmic contact members (not illustrated) may be further formed on the first semiconductor 154h and the second semiconductor 154l, respectively. The ohmic contact members may be made of a material such as silicide or n+ hydrogenated amorphous silicon to which an n-type impurity is doped at a high concentration.

The first data line 171h, the second data line 171l, a first source electrode 173h, a first drain electrode 175h, a second source electrode 173l, and a second drain electrode 175l are formed on the first semiconductor 154h, the second semiconductor 154l, and the gate insulating layer 140.

The first data line 171h and the second data line 171l transfer the data signal and extend in a second direction to cross the gate line 121 and the storage electrode line 131. The data line 171 is positioned between the two microcavities 305 that are adjacent in the horizontal direction. That is, the data line 171 is positioned in the second valley V2.

The first data line 171h and the second data line 171l transfer different data voltages. For example, the data voltage transferred by the second data line 171l may be lower than the data voltage transferred by the first data line 171h.

The first source electrode 173h is formed to protrude from the first data line 171h and overlap with the first gate electrode 124h. The second source electrode 173l is formed to protrude from the second data line 171l and overlap the second gate electrode 124l. Each of the first drain electrode 175h and the second drain electrode 175l includes one wide end portion and a narrower rod-shaped end portion. The wide end portions of the first drain electrode 175h and the second drain electrode 175l overlap with the storage electrode 135 protruding from the storage electrode line 131. The rod-shaped end portions of the first drain electrode 175h and the second drain electrode 175l are partially surrounded by the first source electrode 173h and the second source electrode 173l, respectively.

The first and second gate electrodes 124h and 124l, the first and second source electrodes 173h and 173l, and the first and second drain electrodes 175h and 175l form the first and second thin film transistors (TFT) Qh and Ql together with the first and second semiconductors 154h and 154l. A channel of the thin film transistor is formed in each of the semiconductors 154h and 154l between each of the source electrodes 173h and 173l and each of the drain electrodes 175h and 175l, respectively.

A passivation layer 180 is formed on the first data line 171h, the second data line 171l, the first source electrode 173h, the first drain electrode 175h, the first semiconductor 154h exposed between the first source electrode 173h and the first drain electrode 175h, the second source electrode 173l, the second drain electrode 175l, and the second semiconductor 154l exposed between the second source electrode 173l and the second drain electrode 175l. The passivation layer 180 may be formed of an organic insulating material or the inorganic insulating material as a single layer or multilayers.

A color filter 230 is formed in each pixel PX on the passivation layer 180. Each color filter 230 may display any one of the primary colors, such as red, green, and blue. The color filter 230 is not limited to the three primary colors of red, green, and blue, and may display cyan, magenta, yellow, and white-based colors. In the embodiment shown in FIG. 7, the color filter 230 is not formed in the first valley V1.

A light blocking member 220 is formed in a region between the adjacent color filters 230. The light blocking member 220 is formed on a boundary of the pixel PX and the thin film transistors Qh and Ql to prevent light leakage. That is, the light blocking member 220 may be formed at the first valley V1 and the second valley V2. The color filter 230 and the light blocking member 220 may overlap with each other in a partial region.

A first insulating layer 240 may be further formed on the color filter 230 and the light blocking member 220. The first insulating layer 240 may be made of an organic insulating material and serve to planarize the color filters 230. In some embodiments, the first insulating layer 240 may be omitted.

A second insulating layer 250 may be further formed on the first insulating layer 240. The second insulating layer 250 may be made of an inorganic insulating material and serve to protect the color filters 230 and the first insulating layer 240. In some embodiments, the second insulating layer 250 may be omitted.

In the passivation layer 180, the first insulating layer 240, and the second insulating layer 250, a first contact hole 181h exposing the wide end portion of the first drain electrode 175h and a second contact hole 181l exposing the wide end portion of the second drain electrode 175l are formed.

A pixel electrode 191 is formed on the second insulating layer 250. The pixel electrode 191 may be made of a transparent metal material such as indium tin oxide (ITO) and indium zinc oxide (IZO). The pixel electrode 191 includes a first subpixel electrode 191h and a second subpixel electrode 191l that are separated from each other with the gate line 121 and the storage electrode line 131 therebetween. The first subpixel electrode 191h and the second subpixel electrode 191l are separated from each other with the first valley V1 therebetween. The first subpixel electrode 191h is positioned in the first subpixel PXa. The second subpixel electrode 191l is positioned in the second subpixel PXb.

The first subpixel electrode 191h is connected with the first drain electrode 175h through the first contact hole 181h. The second subpixel electrode 191l is connected to the second drain electrode 175l through the second contact hole 181l. Accordingly, when the first thin film transistor Qh and the second thin film transistor Ql are turned on, the first subpixel electrode 191h and the second subpixel electrode 191l receive different data voltages from the first drain electrode 175h and the second drain electrode 175l, respectively. During this time, an electric field may be generated between the pixel electrode 191 and a common electrode 270.

As FIG. 6 illustrates, an overall shape of each of the first subpixel electrode 191h and the second subpixel electrode 191l is a quadrangle. The first subpixel electrode 191h and the second subpixel electrode 191l include horizontal stems 193h and 193l and vertical stems 192h and 192l that cross the horizontal stems 193h and 193l, respectively. Further, each of the first subpixel electrode 191h and the second subpixel electrode 191l includes a plurality of minute branches 194h and 194l.

Each of the first and second subpixel electrodes 191h and 191l is divided into four sub-regions by the horizontal stems 193h and 193l and the vertical stems 192h and 192l. The minute branches 194h and 194l obliquely extend from the horizontal stems 193h and 193l and the vertical stems 192h and 192l. The direction in which the minute branches 194h and 194l extend may form an angle of approximately 45 degrees or 135 degrees with the gate line 121 or the horizontal stems 193h and 193l. Further, extending directions of the minute branches 194h and 194l of two adjacent sub-regions may be perpendicular to each other. As the exemplary embodiment of FIG. 6 shows, the first subpixel electrode 191h and the second subpixel electrode 191l may further include outer stems that surround the outsides of the first subpixel PXa and the second subpixel PXb.

The layout form of the pixel, the structure of the thin film transistor, and the shape of the pixel electrode described above are just examples. The present system and method are not limited thereto and may be variously modified.

The common electrode 270 is formed on the pixel electrode 191 so as to be spaced apart from the pixel electrode 191 by a predetermined distance. The microcavity 305 is formed between the pixel electrode 191 and the common electrode 270. That is, the microcavity 305 is surrounded by the pixel electrode 191 and the common electrode 270. The common electrode 270 is formed on the microcavity 305 and on the second valley V2 and extends in the horizontal direction. The common electrode 270 is formed to cover an upper surface and a side of the microcavity 305. A width and an area of the microcavity 305 may be variously modified according to a size and a resolution of the display device.

In each pixel PX, the common electrode 270 separated from the substrate 110 by the microcavity 305 in the area where the pixel electrode 191 is formed. The common electrode 270 is not separated from the substrate 110 by the microcavity 305 and is formed to be attached to the insulating layer 250 at the second valleys V2. That is, at the second valleys V2, the common electrode 270 is formed directly on the second insulating layer 250.

The common electrode 270 has substantially the same planar shape as the roof layer 1360. In the second valleys V2, the planar shape of the portion in which the common electrode 270 adheres to the insulating layer 250 (i.e., not separated by a microcavity 305) may have substantially the same shape as the planar shape of the partition 1365 of the roof layer 1360. For example, in the case shown in FIG. 6, the planar shape of the portion in which the common electrode 270 adheres to the insulating layer 250 has a zigzag shape.

The common electrode 270 may be made of a transparent metal material such as indium tin oxide (ITO) and indium zinc oxide (IZO). A predetermined voltage may be applied to the common electrode 270, and an electric field may be generated between the pixel electrode 191 and the common electrode 270.

A first alignment layer 11 is formed on the pixel electrode 191. The first alignment layer 11 may also be formed directly on the second insulating layer 250 in areas that are not covered by the pixel electrode 191. A second alignment layer 21 is formed below the common electrode 270 and faces the first alignment layer 11. The first alignment layer 11 and the second alignment layer 21 may be formed as vertical alignment layers and made of alignment materials such as polyamic acid, polysiloxane, and polyimide. The first and second alignment layers 11 and 21 may be connected to each other at a lateral surface of an edge of the microcavity 305.

A liquid crystal layer configured by liquid crystal molecules 310 is formed in the microcavity 305 positioned between the pixel electrode 191 and the common electrode 270. The liquid crystal molecules 310 may have negative dielectric anisotropy and, thus, stand up in a vertical direction to the substrate 110 when no electric field is applied. That is, vertical alignment may be performed.

The first subpixel electrode 191h and the second subpixel electrode 191l to which the data voltages are applied generate an electric field together with the common electrode 270 to control the orientations of the liquid crystal molecules 310 (e.g., direction in which an axis of a liquid crystal molecule points) is positioned in the microcavity 305 between the two electrodes 191 and 270. Luminance of light passing through the liquid crystal layer varies according to the orientations of the liquid crystal molecules 310.

A third insulating layer 350 may be further formed on the common electrode 270. The third insulating layer 350 may be made of an inorganic insulating material such as a silicon nitride (SiNx) and a silicon oxide (SiOx), and may be omitted in some cases.

A roof layer 1360 is formed on the third insulating layer 350. The roof layer 1360 may be made of an organic material. The roof layer 1360 is formed on the microcavity 305 and on the second valley V2 and extends in the horizontal direction. The roof layer 1360 is formed to cover the upper surface and a side of the microcavity 305. The roof layer 1360 may be hardened by a curing process to serve to maintain the shape of the microcavity 305. The roof layer 1360 is formed to be spaced apart from the pixel electrode 191 with the microcavity 305 therebetween.

The common electrode 270 and the roof layer 1360 are formed such that one or more lateral edge surfaces of the microcavity 305 are exposed by the injection holes 307a and 307b. The first injection hole 307a exposes a lateral surface of a first edge of the microcavity 305. The second injection hole 307b exposes a lateral surface of a second edge of the microcavity 305. The first edge and the second edge are edges that face each other. For example, in the top plan view of FIG. 6, the first edge may be an upper edge of the microcavity 305 and the second edge may be a lower edge of the microcavity 305. The injection holes 307a and 307b expose edge sides of the microcavity 305 adjacent to the first valley V1. Since the microcavity 305 is exposed by the injection holes 307a and 307b, an aligning agent, a liquid crystal material, or the like may be injected into the microcavity 305 through the injection holes 307a and 307b.

The common electrode 270 and the roof layer 1360 are formed on the microcavity 305, including its edges, except for the edge portions where the injection hole 307a and 307b are formed. That is, the common electrode 270 and the roof layer 1360 are formed such that the side of the right and left edges of the microcavity 305 are covered. The partition 1365 is a portion of the roof layer 1360 that is formed between a plurality of microcavities 305. For example, the partition 1365 is formed at the second valleys V2 to separate the adjacent microcavities 305. According to an exemplary embodiment of the present system and method, the planar shape of the partition 1365 positioned at the center of the display device is a zigzag shape.

A fourth insulating layer 370 may be further formed on the roof layer 1360. The fourth insulating layer 370 may be made of an inorganic insulating material such as a silicon nitride (SiNx) and a silicon oxide (SiOx). The fourth insulating layer 370 may be formed to cover the upper surface and the side of the roof layer 1360. The fourth insulating layer 370 serves to protect a roof layer 1360 made of an organic material, and may be omitted in some cases.

An encapsulation layer 390 is formed on the fourth insulating layer 370. The encapsulation layer 390 covers the injection holes 307a and 307b to prevent the microcavity 305 from being exposed to the outside. That is, the encapsulation layer 390 may seal the microcavity 305 so that the liquid crystal molecules 310 formed in the microcavity 305 are not discharged outside. Since the encapsulation layer 390 contacts the liquid crystal molecules 310, the encapsulation layer 390 may be made of a material that does not react with the liquid crystal molecules 310. For example, the encapsulation layer 390 may be made of parylene and the like.

The encapsulation layer 390 may be formed as a multilayer such as double layers and triple layers. The double layers may be configured as two layers made of different materials. The triple layers may be configured as three layers so that materials of adjacent layers are different from each other. For example, the encapsulation layer 390 may include a layer made of an organic insulating material and a layer made of an inorganic insulating material.

Although not illustrated, polarizers may be further formed on upper and lower sides of the display device. The polarizers may be include a first polarizer and a second polarizer. The first polarizer may be attached onto the lower side of the substrate 110, and the second polarizer may be attached onto the encapsulation layer 390.

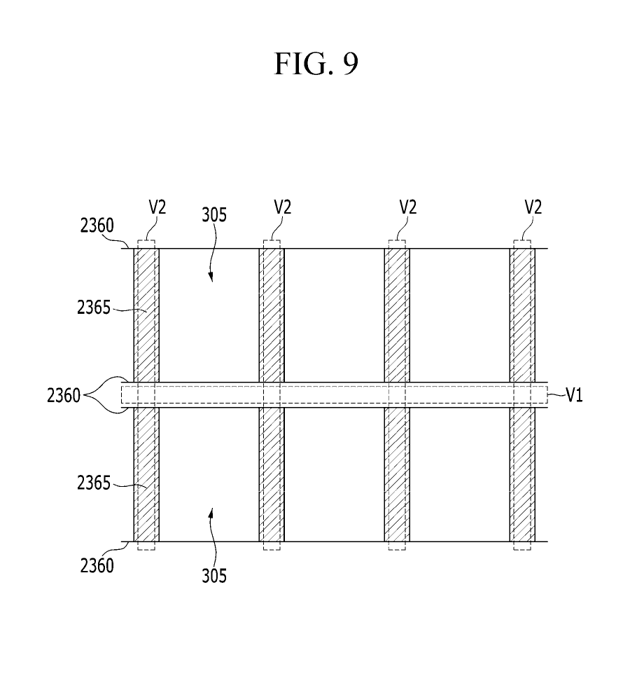

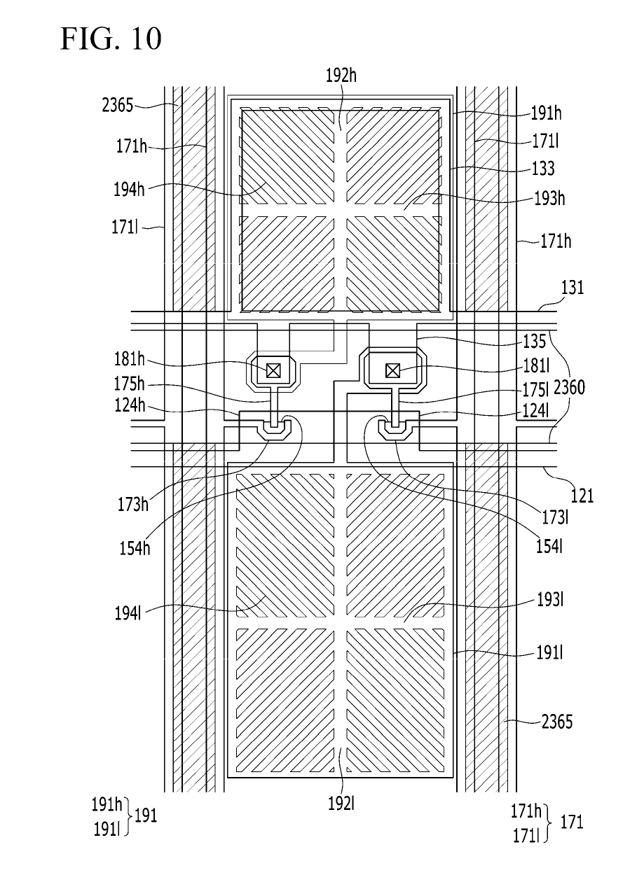

The pixels positioned at the edge of a display device according to the exemplary embodiment of the present system and method are described below with reference to FIG. 9 and FIG. 10. As used herein, an “edge of a display device” may encompass an edge region of the display device. The edge region, for example, may be located near an endpoint of a length of the display.

FIG. 9 is a top plan view of a portion of a display device according to an exemplary embodiment of the present system and method. FIG. 10 is a top plan view of one pixel of a display device according to an exemplary embodiment of the present system and method. FIG. 9 and FIG. 10 show the pixels positioned at the edge of the display device.

According to an exemplary embodiment of the present system and method, the shape of the pixels positioned at the edge of the display device is similar to the shape of the pixels positioned at the center, but may differ in the shape of the partial constituent elements between the center and the edge of the display device. That is, the same layers are formed and the formation sequence is the same. Hereafter, the difference in the shape of the partition that separates adjacent microcavities is described.

The microcavity 305 covered by a roof layer 2360 is formed, the roof layer 2360 is formed to extend in the horizontal direction, and the roof layer 2360 includes a partition 2365 formed between a plurality of microcavities 305.

The partition 2365 is formed to extend in the vertical direction and is disposed between the microcavities 305 that are adjacent to one another in the horizontal direction, thereby separating the adjacent microcavities 305. According to an exemplary embodiment of the present system and method, the planar shape of the partition 2365 positioned at the edge of the display device is a bar shape.

In a display device according to an exemplary embodiment of the present system and method, the shape of a partition that separates the microcavities containing liquid crystal molecules differs according to the position along a length of the substrate where the partition is situated. Particularly, the planar shape of a partition positioned at the center of the substrate is different from the planar shape of a partition positioned at the edges of the substrate. The planar shape of the partition positioned at the center of the substrate is a zigzag shape. The planar shape of the partition positioned at the edge of the substrate is a bar shape.

When the planar shape of the partition is a zigzag shape, the area of the roof layer that adheres to the substrate is increased such that the bending resistance is stronger than if the planar shape of the partition is a bar shape. Accordingly, the structures that have a stronger bending resistance are used at the center of the substrate where it receives more bending force during the bending process, and the structures that have a weaker bending resistance are used at both of the edges of the substrate where it receives less bending force during the bending process. Varying the partition shapes in this manner in a display device enables a constant curvature to be formed on the display device.

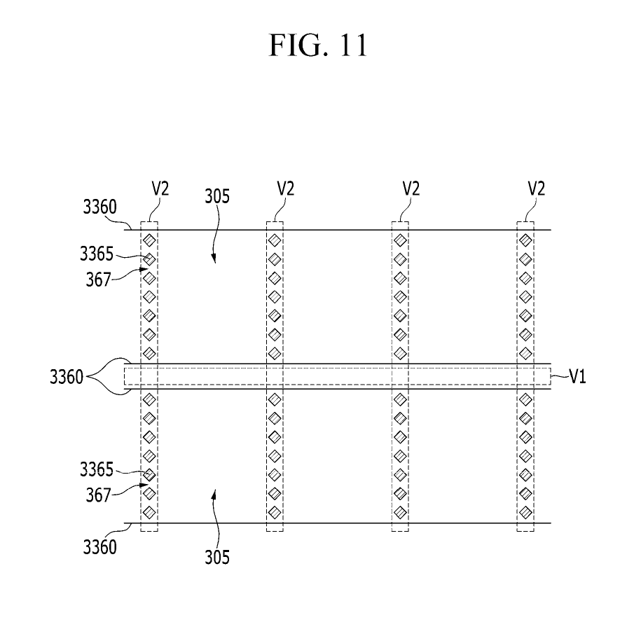

A display device according to an exemplary embodiment of the present system and method is described with reference to FIG. 11 to FIG. 15. The display device shown in FIG. 11 to FIG. 15 differs from those shown in FIG. 1 to FIG. 10 at least in the shape of the partitions separating the microcavities.

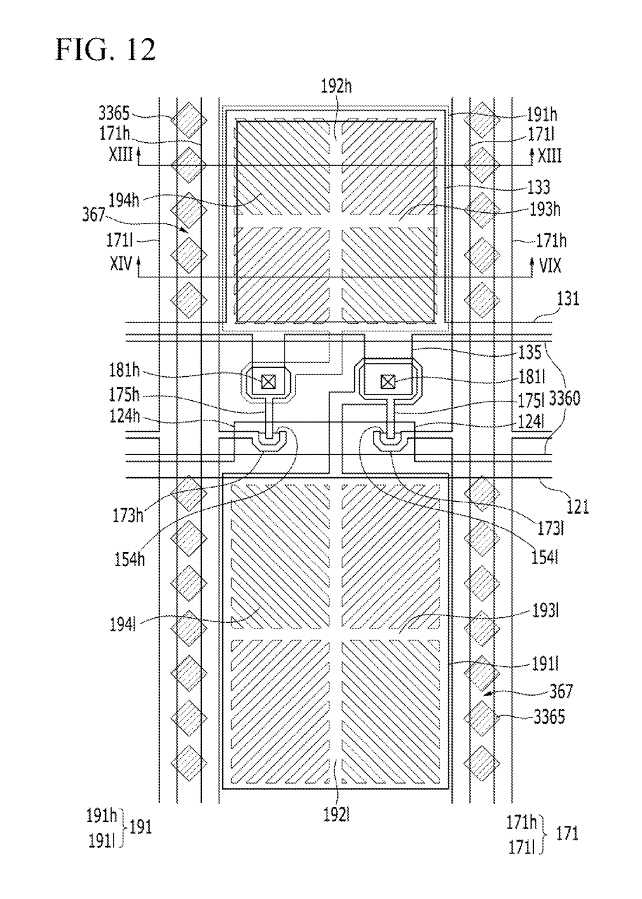

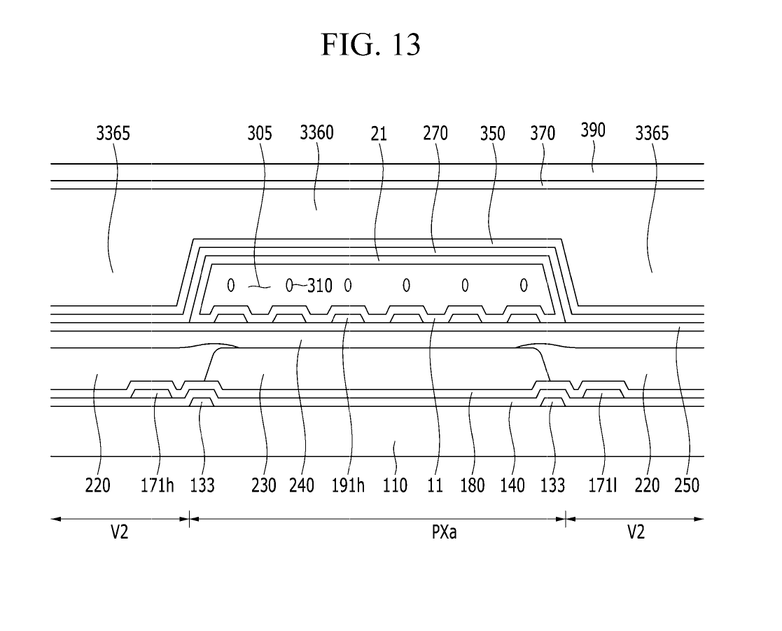

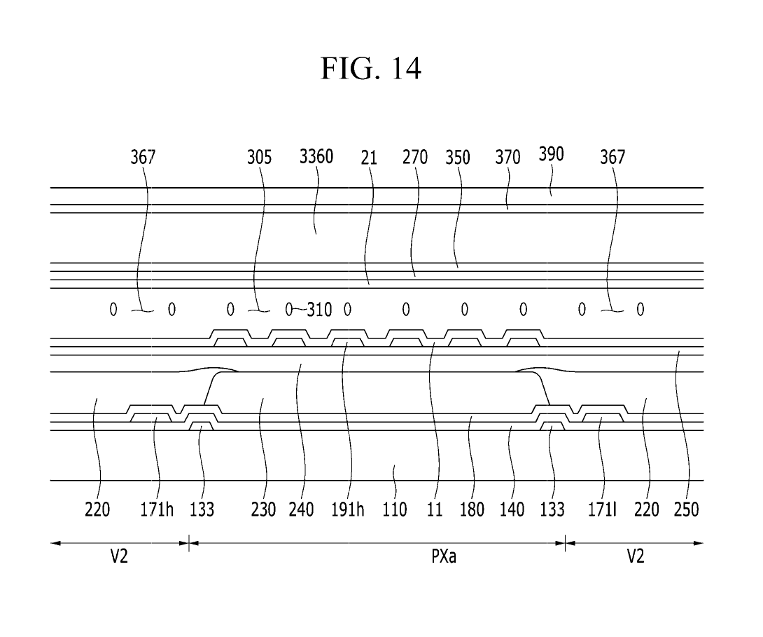

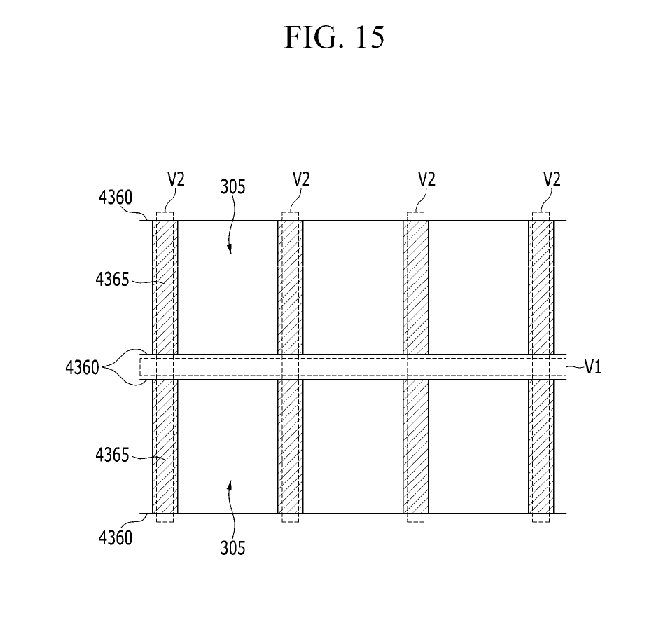

FIG. 11 is a top plan view of a portion of a display device according to an exemplary embodiment of the present system and method. FIG. 12 is a top plan view of one pixel of a display device according to an exemplary embodiment of the present system and method. FIG. 13 is a cross-sectional view of the display device FIG. 12 taken along a line XIII-XIII, according to an exemplary embodiment of the present system and method. FIG. 14 is a cross-sectional view of the display device FIG. 12 taken along a line XIV-XIV, according to an exemplary embodiment of the present system and method. FIG. 11 to FIG. 14 show the pixels positioned at the center of the display device. FIG. 15 is a top plan view of another portion of a display device according to an exemplary embodiment of the present system and method. FIG. 15 shows the pixels positioned at the edge of the display device.

The structure of the pixel positioned at the center of a display device according to an exemplary embodiment of the present system and method is described with reference to FIG. 11 to FIG. 14. The microcavity 305 covered by a roof layer 3360 is formed on the substrate 110, the roof layer 3360 is formed to extend in the horizontal direction, and the roof layer 3360 includes a partition 3365 formed between a plurality of microcavities 305.

The partition 3365 is formed to extend in the vertical direction and is disposed between the microcavities 305 that are adjacent to one another in the horizontal direction, thereby separating the adjacent microcavities 305. The partition 3365 positioned at the edge of the display device according to an exemplary embodiment of the present system and method includes a plurality of quadrangles.

In this case, a partition 3365 includes a plurality of quadrangles that are disposed and spaced apart from each other by a predetermined distance in the vertical direction. That is, instead of a continuous partition that extends a length of a second valley V2, the partition 3365 is disposed along the length of the second valley V2 as a plurality of quadrangles. Accordingly, the adjacent microcavities 305 may be connected at the portions between adjacent quadrangles of the partition 3365. For example, as FIG. 11 illustrates, a path 367 may connect adjacent microcavities 305.

As FIG. 14 illustrates, the roof layer 3360 and third insulating layer 350 are separated from the substrate 110 by liquid crystal molecules 310 at the portion where the path 367 is formed. This separation provides a stronger resistance to bending compared to the portion shown in FIG. 13 where the roof layer 3360 and the third insulating layer 350 are adhered to the substrate 110. Accordingly, the portion where the path 367 is formed between adjacent quadrangles of the partition 3365 has a stronger bending resistance than the portion where the path 367 is not formed.

The structure of the pixel positioned at the edge of a display device according to an exemplary embodiment of the present system and method is described with reference to FIG. 15.

According to an exemplary embodiment of the present system and method, the shape of the pixel positioned at the edge of the display device is similar to the shape of the pixel positioned at the center, but may differ in the shape of the partial constituent elements between the center and the edge of the display device. That is, the same layers are formed and the formation sequence is the same. Hereafter, the difference in the shape of the partition that separates adjacent microcavities is described.

A roof layer 4360 is formed to extend in the horizontal direction. A partition 4365 is formed to extend in the vertical direction and disposed between the right and left adjacent microcavities 305, thereby separating the adjacent microcavities 305. According to an exemplary embodiment of the present system and method, the planar shape of the partition 4365 positioned at the edge of the display device is a bar shape. Unlike the display device of FIG. 11, the partition 4365 positioned at the edge of the display device extends continuously along the second valley V2 and is not separated by paths (e.g., path 367 in FIG. 11).

In a display device according to an exemplary embodiment of the present system and method, the shape of a partition that separates the microcavities containing liquid crystal molecules differs according to the position along a length of the substrate where the partition is situated. Particularly, the planar shape of a partition positioned at the center of the substrate is different from the planar shape of a partition positioned at the edges of the substrate. The partition positioned at the center of the substrate includes a plurality of quadrangles (e.g., rhombus shaped structures) that are spaced apart from one another by a predetermined distance. The planar shape of the partition positioned at the edge of the substrate is a bar shape. The partition positioned at the center of the substrate includes paths in the spaces between the plurality of quadrangles, and the partition positioned at the edge of the substrate does not include the paths. The paths connect adjacent microcavities.

As described above, the portion where the path is formed at the partition has a stronger bending resistance than the portion where the path 367 is not formed. Thus, because the partition positioned at the center of the substrate includes portions where the paths are formed, it has a bending resistance that is relatively stronger compared to the partition at the edge of the substrate. Accordingly, the structures that have a stronger bending resistance are used at the center of the substrate where it receives more bending force during the bending process, and the structures have a weaker bending resistance are used at the edges of the substrate where it receives less bending force during the bending process. Varying the partition shapes in this manner in a display device enables a constant curvature to be formed on the display device.

Although in the above-described embodiment the partition positioned at the center of the substrate includes a plurality of quadrangles, the present system and method are not limited thereto. The partition positioned at the center of the substrate may include structures having various other shapes such as a circle and a triangle, instead of a quadrangle.

Also, although the roof layer is described above as being formed to extend in the horizontal direction and the partition being formed to extend in the vertical direction, the present system and method are not limited thereto. The roof layer may be formed to extend in the vertical direction and the partition may be formed to extend in the horizontal direction.

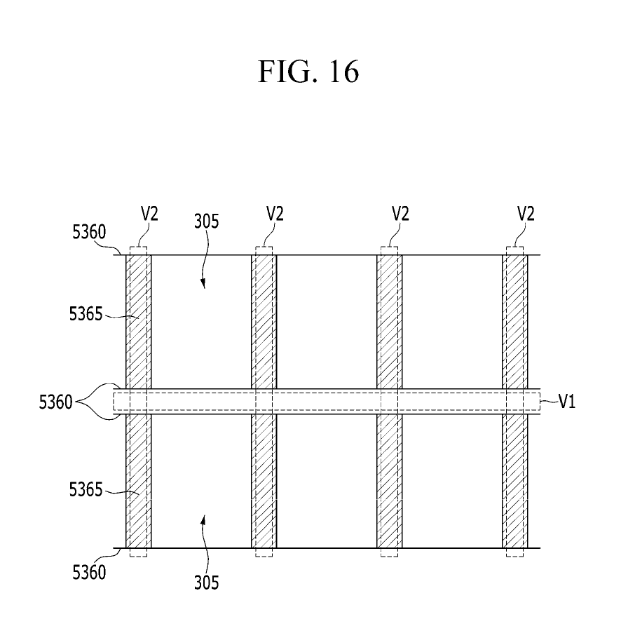

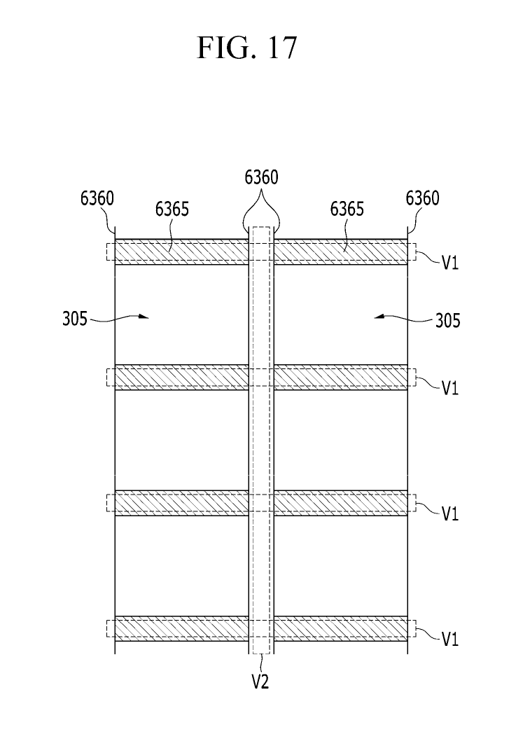

A display device according to an exemplary embodiment of the present system and method is described with reference to FIG. 16 and FIG. 17. The display device of FIG. 16 and FIG. 17 differs from those shown in FIG. 1 to FIG. 10 at least in the shape of the partitions separating the microcavities.

FIG. 16 is a top plan view of a portion of a display device according to an exemplary embodiment of the present system and method. FIG. 17 is a top plan view of another portion of a display device according to an exemplary embodiment of the present system and method. FIG. 16 shows the pixels positioned at the center of the display device. FIG. 17 shows the pixels positioned at the edge of the display device.

The structure of the pixel positioned at the center of a display device according to an exemplary embodiment of the present invention is described with reference to FIG. 16. The microcavity 305 covered by a roof layer 5360 is formed on the substrate 110. The roof layer 5360 is formed to extend in the horizontal direction. A plurality of roof layers 5360 are separated from each other with the first valleys V1 therebetween. According to an embodiment, a roof layer may have portions removed between the microcavities 305 that are adjacent to each other in the vertical direction to form the plurality of roof layers 5360.

The roof layer 5360 includes a partition 5365 formed between a plurality of microcavities 305. The partition 5365 is formed to extend in the vertical direction and is disposed between the microcavities 305 that are adjacent to one another in the horizontal direction, thereby separating the adjacent microcavities 305. The planar shape of the partition 5365 positioned at the edge of the display device according to an exemplary embodiment of the present system and method is a bar shape.

Although the roof layer is described above as being formed to extend in the horizontal direction and the partition being formed to extend in the vertical direction, the present system and method are not limited thereto. When changing the bending direction of the substrate, the formation direction of the roof layer and partition may be changed. For example, when the bending direction of the substrate is the vertical direction, the roof layer may be formed to extend in the vertical direction and the partition may be formed to extend in the horizontal direction.

The structure of the pixel positioned at the edge of a display device according to an exemplary embodiment of the present system and method is described with reference to FIG. 17. The microcavity 305 covered by the roof layer 6360 is formed on the substrate 110. The roof layer 6360 is formed to extend in the vertical direction. A plurality of roof layers 6360 are separated from each other with the second valleys V2 therebetween. According to an embodiment, a roof layer may have portions removed between the microcavities 305 that are adjacent to each other in the vertical direction to form the plurality of roof layers 6360.

The roof layer 6360 includes a partition 6365 formed between a plurality of microcavities 305. The partition 6365 is formed in the horizontal direction and is disposed between the microcavities 305 that are adjacent to one another in the vertical direction, thereby separating the adjacent microcavities 305. The planar shape of the partition 5365 positioned at the edge of the display device according to an exemplary embodiment of the present system and method is a bar shape.

Although the roof layer is described above as being formed to extend in the vertical direction and the partition being formed to extend in the horizontal direction, the present system and method are not limited thereto. When changing the bending direction of the substrate, the formation direction of the roof layer and partition may be changed. For example, when the bending direction of the substrate is the vertical direction, the roof layer may be formed to extend in the horizontal direction and the partition may be formed to extend in the vertical direction.

In a display device according to an exemplary embodiment of the present system and method, the shape of a partition that separates the microcavities containing liquid crystal molecules differs according to the position along a length of the substrate where the partition is situated. Particularly, the planar shape of a partition positioned at the center of the substrate is different from the planar shape of a partition positioned at the edges of the substrate. Also, the planar shape of a roof layer positioned at the center of the substrate is different from the planar shape of a roof layer positioned at the edges of the substrate.

The roof layer positioned at the center of the substrate extends in the horizontal direction, which increases its bending resistance when the bending direction of the substrate is also in the horizontal direction. In contrast, the roof layer positioned at the edge of the substrate extends in the vertical direction. Furthermore, the roof layer is removed between microcavities that are adjacent to one another in the horizontal direction, which decreases its bending resistance when the bending direction is in the horizontal direction. Accordingly, the structures that have a stronger bending resistance are used at the center of the substrate where it receives more bending force during the bending process, and the structures that have a weaker bending resistance are used at the edges of the substrate where it receives less bending force during the bending process. Varying the roof layer structures in this manner in a display device enables a constant curvature to be formed on the display device.

While the present system and method are described above in connection with exemplary embodiments, it is understood that the present system and method are not limited to these embodiments.

<Description of Symbols>

| | |
|---|---|
| 1000: display device | 110: substrate |
| 121: gate line | 131: storage electrode line |
| 171: data line | 191h: first pixel electrode |
| 1911: second pixel electrode | 220: light blocking member |
| 230: color filter | 270: common electrode |
| 305: microcavity | 307a, 307b: injection hole |
| 310: liquid crystal molecule | 367: path |
| 1360, 2360, 3360, 4360, 5360, 6360: roof layer | |
| 1365, 2365, 3365, 4365, 5365, 6365: partition | |

What is claimed is:

1. A display device comprising:
a bendable substrate;
a thin film transistor formed on the substrate;
a pixel electrode connected to the thin film transistor;
a roof layer disposed on the substrate and separated from the pixel electrode by a first microcavity formed in between;
a liquid crystal layer disposed in the first microcavity; and
an encapsulation layer formed on the roof layer and sealing the first microcavity,
wherein the roof layer includes a partition formed between the first microcavity and a second microcavity adjacent to the first microcavity, and
a shape of the partition differs according to a position along a length of the substrate where the partition is disposed.

2. The display device of claim 1, wherein
a planar shape of the partition positioned at a center of the substrate is different from the planar shape of the partition positioned at an edge of the substrate.

3. The display device of claim 2, wherein
the planar shape of the partition positioned at the center of the substrate is a zigzag shape.

4. The display device of claim 3, wherein
the planar shape of the partition positioned at the edge of the substrate is a bar shape.

5. The display device of claim 4, wherein:
the partition is formed to extend along a first direction; and
the roof layer is formed to extend along a second direction perpendicular to the first direction.

6. The display device of claim 5, wherein
the first direction is a vertical direction and the second direction is a horizontal direction.

7. The display device of claim 4, wherein:
the partition is formed between the first and second microcavities adjacent in the horizontal direction; and
the roof layer is removed between the first microcavity and a third microcavity adjacent to the first microcavity in the vertical direction.

8. The display device of claim 2, wherein
a path is formed in the partition positioned at the center of the substrate.

9. The display device of claim 8, wherein
the planar shape of the partition positioned at the center of the substrate is at least one of a quadrangle, a circle, and a triangle.

10. The display device of claim 9, wherein
the planar shape of the partition positioned at the edge of the substrate is a bar shape.

11. The display device of claim 10, wherein:
the partition is formed along a first direction; and
the roof layer is formed along a second direction perpendicular to the first direction.

12. The display device of claim 11, wherein
the first direction is the vertical direction, and the second direction is the horizontal direction.

13. The display device of claim 1, wherein
the formation direction of the partition positioned at a center of the substrate is different from the formation direction of the partition positioned at an edge of the substrate.

14. The display device of claim 13, wherein
the formation direction of the partition positioned at the center of the substrate is a first direction.

15. The display device of claim 14, wherein
the formation direction of the partition positioned at an edge of the substrate is a second direction perpendicular to the first direction.

16. The display device of claim 15, wherein
the roof layer positioned at the center of the substrate is formed along the second direction.

17. The display device of claim 16, wherein
the roof layer positioned at the edge of the substrate is formed along the first direction.

18. The display device of claim 17, wherein
the first direction is the vertical direction, and the second direction is the horizontal direction.

19. The display device of claim 15, wherein:
the partition positioned at the center of the substrate is formed between the first and second microcavities adjacent in the horizontal direction; and
the roof layer positioned at the center of the substrate is removed between the first microcavity and a third microcavity adjacent to the first microcavity in the vertical direction.

20. The display device of claim 19, wherein:
the partition positioned at the edge of the substrate is formed between the first and third microcavities adjacent in the vertical direction; and
the roof layer positioned at the edge of the substrate is removed between the first and second microcavities adjacent in the horizontal direction.
